(19) United States
(12) Patent Application Publication
(10) Pub. No.: US 2010/0162142 A1
(43) Pub. Date: Jun. 24, 2010

(54) COMMON STYLE SHEETS FOR COMPILED AND SCRIPTING LANGUAGE APPLICATIONS

(75) Inventors: Duane Cooper, Rome, PA (US); Charles F. Makarsky, Endicott, NY (US); John Munley, Endwell, NY (US); Nicholas T. Pascarelli, Endicott, NY (US)

Correspondence Address: MICHAEL BEST & FRIEDRICH LLP, 100 E WISCONSIN AVENUE, Suite 3300, MILWAUKEE, WI, 53202, US

(73) Assignee: LOCKHEED MARTIN CORPORATION, Bethesda, MD (US)

(21) Appl. No.: 12/341,578

(22) Filed: Dec. 22, 2008

(51) Int. Cl. G06F 3/00

(52) U.S. Cl. 715/762

(57) ABSTRACT

Systems and methods for presenting common graphical user interfaces in different applications. A scripting language application has a first graphical user interface that includes a first plurality of objects that appear on a display device. An application software program has a second graphical user interface, the second graphical user interface including a second plurality of objects that appear on a display device. The second plurality of objects has an appearance that is substantially identical in appearance to the first plurality of objects. A style sheet common to both the scripting language application and the application software program controls the generation of the first and second pluralities of objects.

### BACKGROUND

Style sheets are commonly used for controlling the graphical user interfaces of scripting language (e.g., web-based) applications. Style sheets are files (generally uncompiled text) that are either separate from or integrated with the scripting language application. The style sheets control one or more of the color, size, placement, etc. of objects of the scripting language application. If a user or developer wishes to modify the graphical user interface of the scripting language application, the user or developer need only change the style sheet. The developer does not need to modify the application itself, allowing easy customization of applications.

The graphical user interface of a compiled application (e.g., a Windows or Apple application) is generally incorporated into the compiled application or generated by configuration files.

### SUMMARY

Changing the graphical user interface of an application that has been developed for both compiled and scripting language applications requires modifying at least two different files—the compiled application or its configuration file, and the scripting language application or its style sheet. This dual modification requires additional time, cost, and effort, and provides opportunities for error.

The present invention relates to systems and methods for developing and deploying compiled and scripting language applications that use a common style sheet to control the graphical user interface of the applications.

In one embodiment, the invention provides a system for presenting common graphical user interfaces in different applications. A scripting language application has a first graphical user interface that includes a first plurality of objects that appear on a display device. An application software program has a second graphical user interface, the second graphical user interface including a second plurality of objects that appear on a display device. The second plurality of objects has an appearance that is substantially identical in appearance to the first plurality of objects, and preferably has a similar layout or arrangement on the display. A style sheet common to both the scripting language application and the application software program controls the generation of the first and second pluralities of objects and their arrangement on the display.

In another embodiment, the invention provides a system that provides graphical user interfaces for different applications. The system includes a display device, a first application, a second application, and a style sheet. The first application is based upon a scripting computer language, and is configured to generate a first graphical user interface including a first plurality of objects that appear on the display device. The second application is based upon a compilable computer language, and is configured to generate a second graphical user interface that includes a second plurality of objects that appear on the display device. The second plurality of objects are substantially identical in appearance to the first plurality of objects, and preferably have the same arrangement on the display. The style sheet is common to both the first application and the second application, and controls the generation of the first and second pluralities of objects.

In another embodiment the invention provides a method of creating graphical user interfaces for a scripting language application and a compilable software program. The method includes creating a common style sheet, providing a scripting language application configured to access the common style sheet, providing a compilable software program configured to access the common style sheet, executing the scripting language application, and executing the compilable software program. Executing the scripting language application includes the steps of accessing the common style sheet and generating a first graphical user interface based at least in part on the style sheet and having a first plurality of objects that appear on a display device. Executing the compilable software program includes the steps of accessing the common style sheet and generating a second graphical user interface based at least in part on the style sheet and having a second plurality of objects that appear on a display device, and have an appearance which is substantially identical to the appearance of the first plurality of objects.

Other aspects of the invention will become apparent by consideration of the detailed description and accompanying drawings.

### BRIEF DESCRIPTION OF THE DRAWINGS

FIG. 1 is a schematic illustration of a customer ordering system incorporating embodiments of the invention.

FIGS. 2A-2D are schematic illustrations of systems incorporating embodiments of the invention.

FIG. 3 is a flow diagram of an embodiment of a method of creating and deploying compiled and scripting language applications using a common style sheet.

FIG. 4 is a flow diagram of a second embodiment of a method of creating and deploying compiled and scripting language applications using a common style sheet.

FIG. 5 is a flow diagram of a third embodiment of a method of creating and deploying compiled and scripting language applications using a common style sheet.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

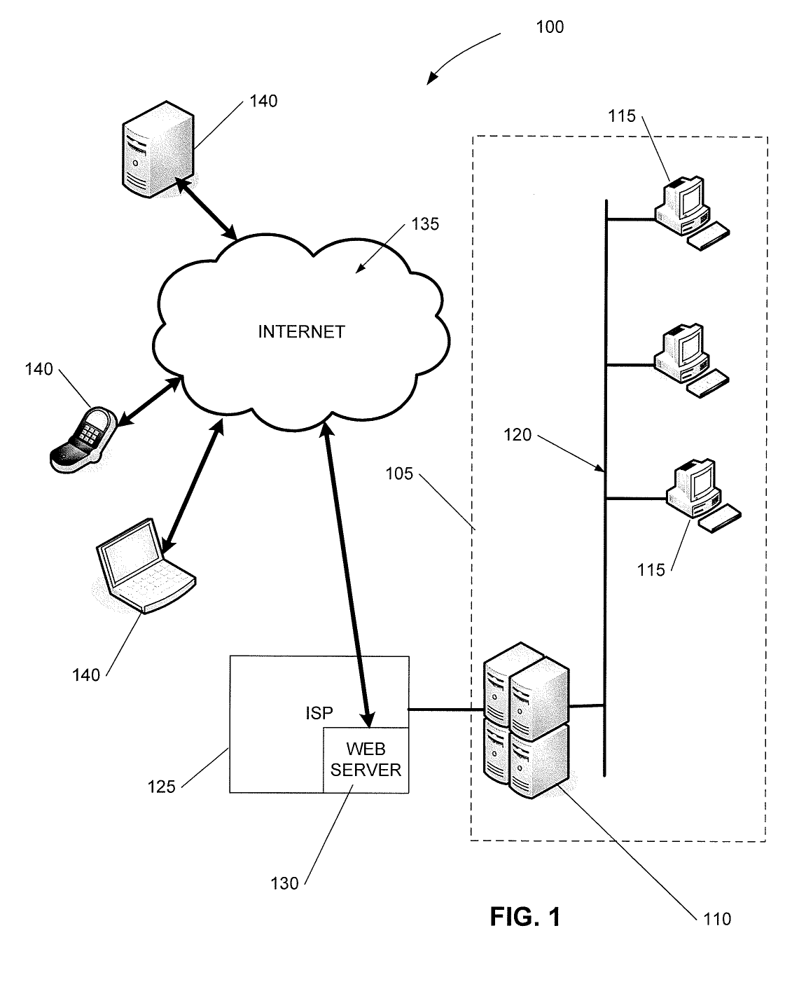

FIG. 1 illustrates a system 100, such as a customer ordering system, incorporating embodiments of the invention. The system 100 includes a call center 105 having a server 110 linked to a plurality of computers 115 via a local area network 120. The server 110 is also linked to an Internet service provider (ISP) 125, which includes a web or other server 130 linked to the Internet 135 or other private or publicly-accessible wide area network. Customers, using input/output devices 140 (e.g., computers, cell phones, mobile email devices, etc.), can access the web server 130 via the Internet 135.

In the system shown in FIG. 1, a customer order application is deployed to the server 110 and installed, from the server 110, onto each of the plurality of computers 115. The server 110 also includes a database for storing customer order data. The customer order data is received by operators at the call center 105, and input by the operators into the plurality of computers using the customer order application. The database also stores customer order data entered by customers using a web-based ordering application running on the devices 140. The devices 140 transfer order data, via the Internet or other network 135, to the web server 130 at the ISP 125. The data is then transferred to the server 110 for storage in the database. The web-based ordering application is stored at the server 130 and is only downloaded to the devices 140 (e.g., web clients) when the devices 140 link to the server 130.

The customer order application is a compiled application and the web-based ordering application is a scripting language application. “Compiled application” refers to an application that runs on a device (e.g., a Wintel or Apple computer) directly, using the resources (e.g., inputs, outputs, etc. accessed through an operating system) of the device. The compiled application is generally compiled into object code, and installed on the device. When run, the compiled application directly accesses the device's operating system, and, through the operating system, the components/resources of the system.

The web-based ordering application is a scripting language application. “Scripting language application” refers to an application that is executed by another application (often a compiled application or an embedded application) on a device (e.g., a thin client, a cell phone, a mobile email device, etc.). The scripting language application is accessed from a remote device (e.g., a web server) by a local device (e.g., a Wintel computer) using a compiled application (e.g., INTERNET EXPLORER, JAVA, etc.), and need not be installed on the local device. Examples of scripting language applications include HTML applications and JAVA-brand applets.

The way an application functions and presents objects (e.g., the layout and/or appearance of text and images) to a user is known as the graphical user interface of the application. Embodiments of the invention provide a common style sheet to control the graphical user interface of a compiled application and a scripting language application such that the graphical user interface of both the compiled and scripting language applications are substantially the same.

In some situations, it may be desirable to have a similar graphical user interface for both a compiled application and a scripting language application. For example, the customer ordering system 100, described above, includes both compiled applications running on the computers 115 which enable operators to enter customer orders, and scripting language applications available over the network 135 for use by customers using the input/output devices 140, enabling the customers to enter orders over the Internet or other network. In some circumstances, the scripting language application may be satisfactory for operators at the call center 105 (e.g., over an intranet) as well as the remote customers. However, it may be desirable for operators at the call center 105 to have functionality beyond that offered in the scripting language application. As such, a compiled application can be deployed at the call center 105. In such a case, it is desirable to maintain a similar graphical user interface for both the compiled application and the scripting language application to reduce employee training and maintenance costs.

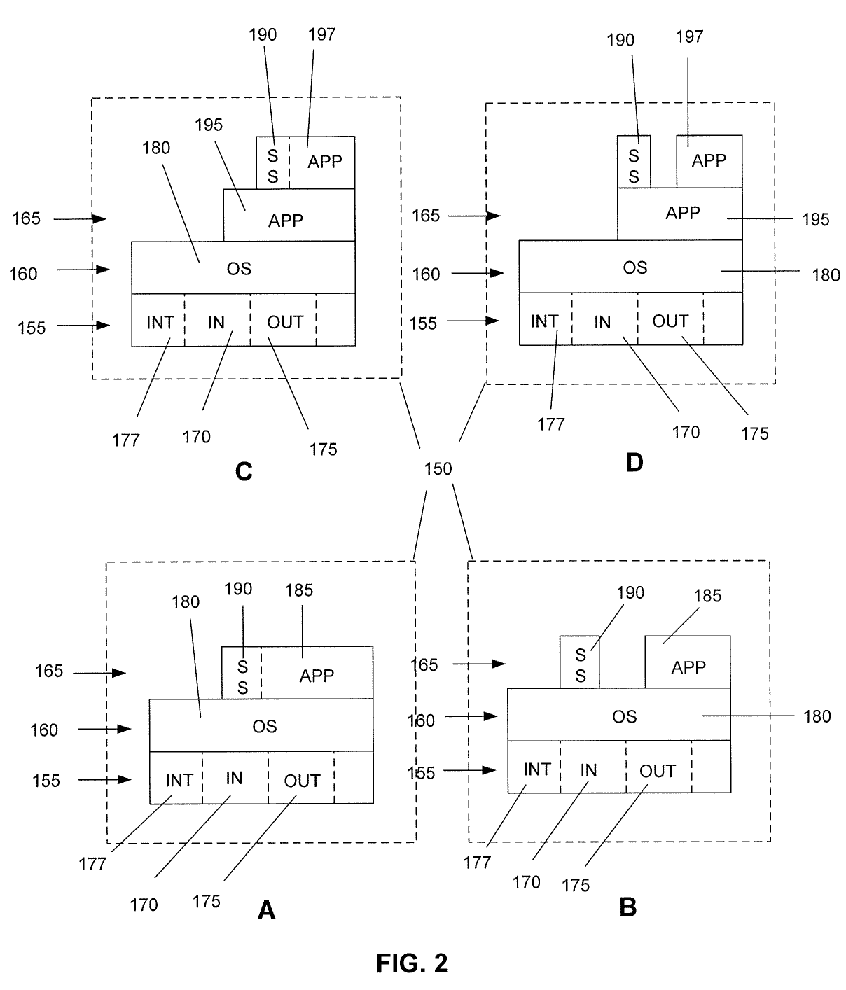

FIGS. 2A-2D schematically illustrate systems incorporating embodiments of the invention for compiled applications (FIGS. 2A and 2B) and scripting language applications (FIGS. 2C and 2D). As shown in FIGS. 2A and 2B a device 150 includes a first (physical) layer 155, a second (operating system) layer 160, and a third (application) layer 165. The first layer 155 represents the hardware (including firmware, e.g., the BIOS) of the device 150. The hardware can include inputs 170 (e.g., a keyboard, a mouse, a touchscreen), outputs 175 (e.g., a display), and an interface 177 (e.g., a network interface—wired and/or wireless). The hardware can also include other components, not shown, such as processors, memory, storage devices, etc. The second layer 160 resides on top of the first layer 155 and generally consists of an operating system 180 (e.g., Windows) which provides applications in the third layer 165 access to the components of the first layer 155. In the embodiment shown, the third layer includes a compiled or compilable application 185. The compiled application 185 is installed on the device 150 and interfaces with the resources of the first layer 155 via the operating system 180. The compiled application 185 receives input/directions from a user via the inputs 170 and provides information (i.e., presents objects) to the user via the outputs 175. The graphical user interface of the compiled application 185 is controlled, at least in part, by a style sheet 190. The compiled application 185 can link to the style sheet 190 in several ways. In the embodiment shown in FIG. 2A, the style sheet 190 has been integrated into the compiled application 185 (e.g., a single object code program contains both the compiled application 185 and the style sheet 190). In the embodiment shown in FIG. 2B, the style sheet 190 resides on the device 150 separate from the compiled application 185. The compiled application 185 accesses the style sheet 190 via the operating system 180. In other embodiments, the style sheet 190 can reside remotely from the device 150 (e.g., on a server or a web-server, where the compiled application 185 accesses the style sheet 190 via a network).

As shown in FIGS. 2C and 2D a device 150 includes a first (physical) layer 155, a second (operating system) layer 160, and a third (application) layer 165. The first layer 155 represents the hardware (including firmware, e.g., the BIOS) of the device 150. The hardware can include inputs 170 (e.g., a keyboard, a mouse, a touchscreen, etc.), outputs 175 (e.g., a display), and an interface 177 (e.g., a network interface—wired and/or wireless). The hardware can also include other components, not shown, such as processors, memory, storage devices, etc. The second layer 160 resides on top of the first layer 155 and generally consists of an operating system 180 which provides applications in the third layer 165 access to the components of the first layer 155.

In the embodiment shown, the third layer includes an application 195. The application 195 can be a compiled application as previously described. In some embodiments, the application 195 is an embedded application (e.g., an Internet access application running on a cell phone device). In some embedded applications, the operating system 180 and the application 195 are integrated together, effectively combining the second and third layers 160 and 165. In the embodiment shown, a scripting language application 197 runs on top of or within the application 195 and interfaces with the resources of the first layer 155 (i.e., the inputs 170 and outputs 175) through the application 195 via the operating system 180. The graphical user interface of the scripting language application 197 is controlled by and presents and arranges objects based on, at least in part, a style sheet 190. The scripting language application 197 can link to the style sheet 190 in several ways. In the embodiment shown in FIG. 2A, the style sheet 190 has been integrated into the scripting language application 197 (e.g., for a hypertext markup language or HTML application, the text of the style sheet 190 is incorporated into the text of the HTML scripting language application 197). In the embodiment shown in FIG. 2B, the style sheet 190 resides on the device 150 separate from the scripting language application 197. The scripting language application 197 accesses the style sheet 190 to determine which objects to display, their appearance, and their arrangement on an output display device. In other embodiments, the style sheet 190 can reside external to the device 150 (e.g., on a server or a web-server, where the scripting language application 197 accesses the style sheet 190 via a network such as a local area network or the Internet). In the embodiment shown, at least one, and preferably all, of the style sheet 190, the application 195, and the scripting language application 197 reside in a computer readable storage device (e.g., a flash memory, a hard disk drive, etc.).

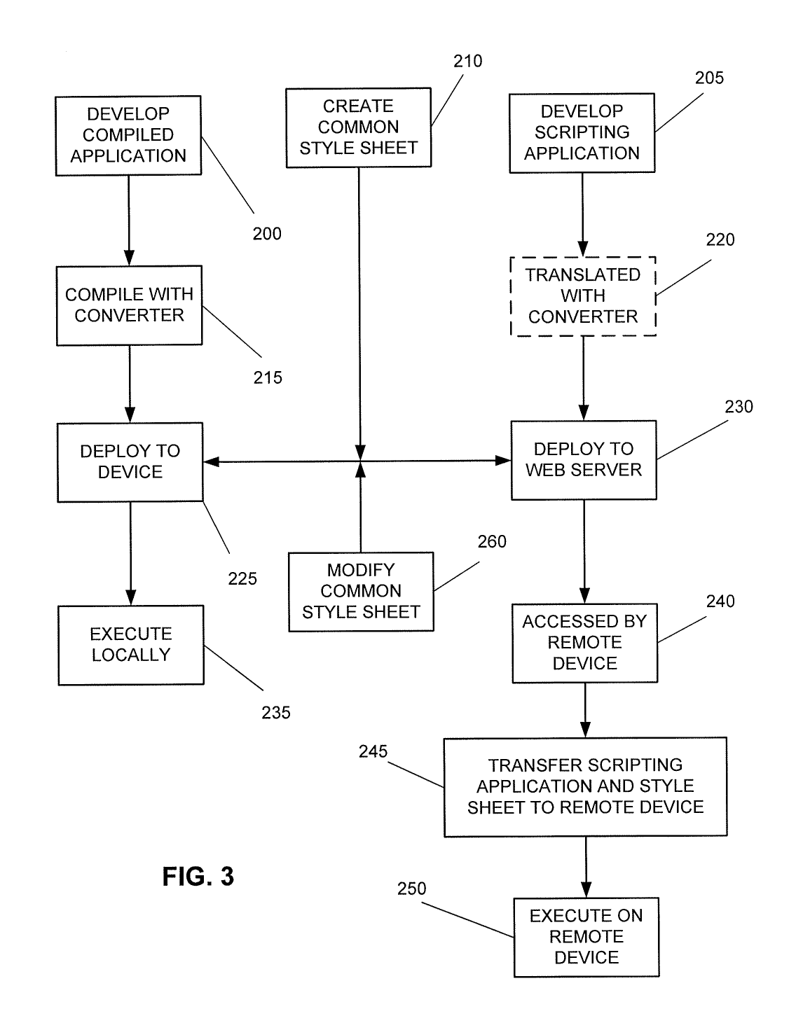

FIG. 3 illustrates an embodiment of a method of deploying compiled applications and scripting language applications wherein the graphical user interfaces of both the compiled application and the scripting language application are controlled, at least in part, by a common style sheet. In the embodiment shown, a style sheet is accessed by the compiled and scripting language applications when the compiled and scripting language applications are executed. The method starts with the development of a compiled application (step 200), a scripting language application (step 205), and a common style sheet (step 210).

The compiled application is developed using a suitable programming language (e.g., Visual Basic) and is targeted to run on a suitable device (e.g., a computer or workstation). The scripting language application is also developed using a suitable programming language (e.g., HTML or JAVASCRIPT) and is designed to run in a suitable environment (e.g., a web or other network browser). The compiled application and the scripting language application can include the same functionality or can have overlapping functionality (e.g., the scripting language application can be a subset of the compiled application). The common style sheet includes attributes that provide directions to the compiled and scripting language applications on how to display and interact with objects of the graphical user interface. In some embodiments, the attributes provide instructions on which objects to display, object layout (e.g., how the object should be displayed—top to bottom, left to right), background color, textual information (e.g., font, font size, color). In some embodiments, the attribute information includes an object name, an object label, an object size, a control type (e.g., text, label, drop down box, etc.), an order identifier (indicating the order on the screen that the control should appear), a group identifier (allowing objects to be grouped together), and a data link (indicating a data or page linkage to the application).

Both the compiled application and the scripting language application are developed to utilize the attributes contained in the common style sheet. The compiled application is compiled (step 215) along with a compiled application runtime converter component. The compiled application runtime converter component enables the compiled application to interface with the common style sheet, converting the attributes of the common style sheet into the appropriate attributes of the compiled application. Also, the scripting language application is translated (step 220) along with a scripting language application runtime converter component. The scripting language application runtime converter component enables the scripting language application to interface with the common style sheet, converting the attributes provided in the common style sheet into the appropriate attributes of the scripting language application. In some embodiments, the common style sheet conforms to a standard style sheet (e.g., a cascading style sheet), where the scripting language application does not require a scripting language application runtime converter to interface with the common style sheet, but instead interfaces directly with the common style sheet. In some embodiments, the runtime converters identify where the style sheet is stored (e.g., a local path).

Next, the compiled application and the common style sheet are deployed to one or more computers (step 225). Deploying the compiled application generally involves installing the compiled application on one or more computers, and storing the common style sheet on the same computers. The scripting language application is deployed, along with the common style sheet, to a web server or other server (step 230). Deploying can also incorporate interim steps such as storing the applications and common style sheet on a server where the applications and common style sheet are accessed by the computers and/or the network server.

When a user wants to run the compiled application, the user simply executes the application on a device to which the compiled application has been deployed (step 235). Running the scripting language application involves a remote device running another application (e.g., INTERNET EXPLORER) which accesses a server on which the scripting language application has been deployed (step 240). The web server then transfers the scripting language application, along with the common style sheet, to the remote device (step 245). The application that accessed the scripting language application on the web server then runs the scripting language application (step 250). In some embodiments, the common style sheet is not transferred to the remote device. Instead, the scripting language application accesses the common style sheet from the web server.

When it is desired to modify the graphical user interface of the compiled and the scripting language applications, a developer modifies the common style sheet (step 260). There is no need to modify the compiled or scripting language applications themselves. Instead once the common style sheet has been modified, the new style sheet is deployed to the computers using the compiled applications (step 225) and to the web server for use by the scripting language applications (step 230). The next time the compiled application is run (step 235) or the scripting language application is accessed and run (steps 240, 245, and 250) the changes in the graphical user interface of the compiled and/or scripting language application, as reflected in the modified style sheet, are implemented.

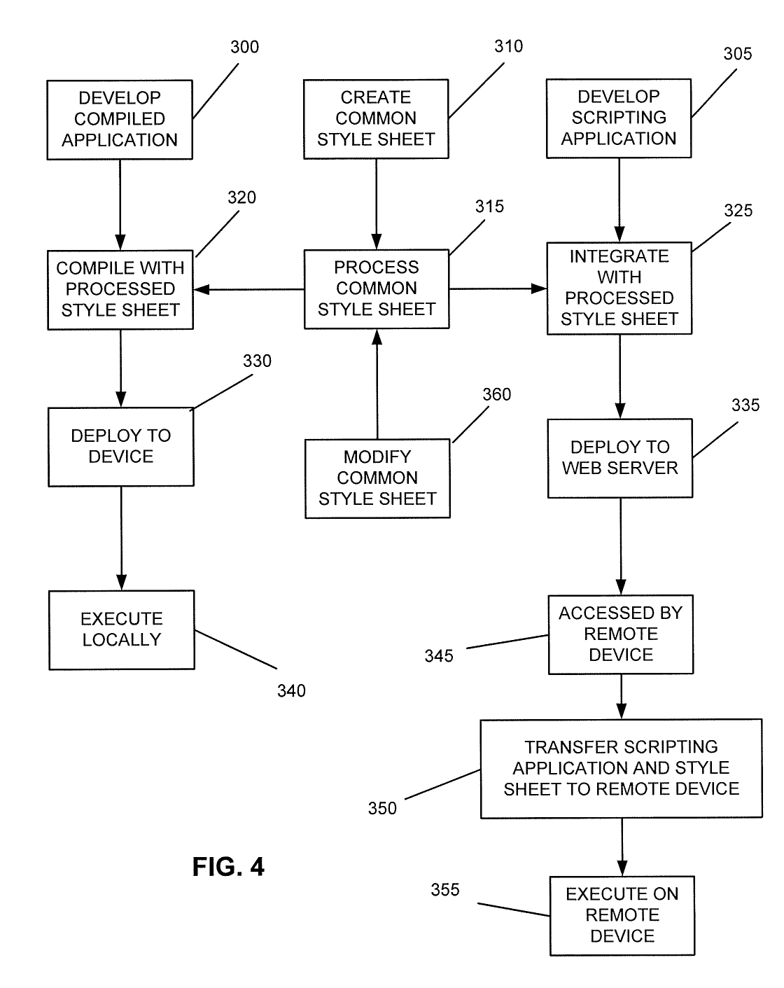

FIG. 4 illustrates a second embodiment of a method of deploying compiled applications and scripting language applications wherein the graphical user interfaces of both the compiled application and the scripting language application are controlled, at least in part, by a common style sheet. In the embodiment shown, a style sheet is incorporated into the compiled and scripting language applications prior to deploying the compiled and scripting language applications. The method starts with the development of a compiled application (step 300), a scripting language application (step 305), and a common style sheet (step 310).

The compiled application is developed using a suitable programming language (e.g., Visual Basic or C) and is targeted to run on a suitable device (e.g., a computer or workstation). The scripting language application is also developed using a suitable programming language (e.g., HTML or JAVASCRIPT) and is targeted to run in a suitable environment (e.g., an Internet or other network browser). The compiled application and the scripting language application can include the same functionality or can have overlapping functionality (e.g., the scripting language application can be a subset of the compiled application). The common style sheet includes attributes that provide directions to the compiled and scripting language applications on which objects to display, how to display and interact with objects of the graphical user interface, and where to display them. As described above, the common style sheet can include attributes providing instructions on object layout, etc.

Next, the common style sheet is processed by a converter (step 315). The converter generates a first set of program code for the compiled application (e.g., a library) and a second set of program code for the scripting language application (e.g., HTML code). In some embodiments, the common style sheet does not need to be converted (e.g., HTML cascaded style sheets). The compiled application is then compiled (step 320) along with the first set of program code. The resulting object code includes the compiled application and the first set of program code. In some embodiments, the scripting language application is also compiled (step 325) along with the second set of program code. In other embodiments, e.g., where the scripting language application is an HTML application, the second set of program code is HTML text, and converting of the scripting language application consists of inserting the second set of program code (i.e., the HTML text of the style sheet) into the HTML text of the scripting language application.

Next the compiled application, which includes the common style sheet, is deployed to one or more computers (step 330). Deploying the compiled application generally involves installing the compiled application on the computer(s). The scripting language application, which also includes the common style sheet, is deployed to a web server (step 335).

When a user wants to run the compiled application, the user simply executes the application on a device to which the compiled application has been deployed (step 340). Running the scripting language application involves a remote device running another application (e.g., an Internet browser like INTERNET EXPLORER) which accesses a web server or other server to which the compiled application has been deployed (step 345). The web server then transfers the scripting language application, along with the integrated common style sheet, to the remote device (step 350). The application that accessed the scripting language application on the web server then runs the scripting language application (step 355).

When it is desired to modify the graphical user interfaces of the compiled and the scripting language applications, a developer modifies the common style sheet (step 360). Again, there is typically no need to modify the compiled or scripting language applications themselves. However, the common style sheet is processed by a converter (step 315). The converter again generates a first set of program code for the compiled application (e.g., a library) and, in some embodiments, a second set of program code for the scripting language application (e.g., HTML code). The compiled application is then compiled (step 320) along with the first set of program code. The resulting object code includes the first set of program code. The scripting language application is also integrated (step 325) with the second set of program code.

Next, the compiled and scripting language applications, which include the common style sheet attributes, are deployed as described above, the new graphical user interface being implemented the next time the compiled and scripting language applications are run.

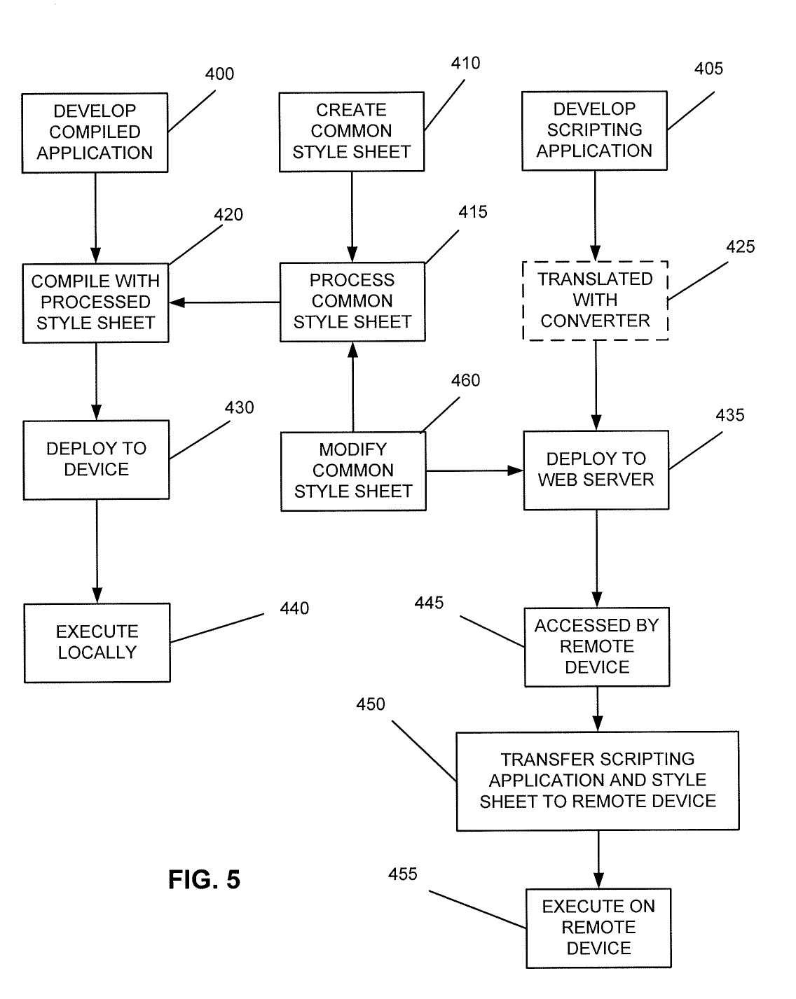

FIG. 5 illustrates a third embodiment of a method of deploying compiled applications and scripting language applications wherein the graphical user interface of both the compiled application and the scripting language application are controlled, at least in part, by a common style sheet. In the embodiment shown, a style sheet is incorporated in the compiled application when the compiled application is compiled, and is accessed by the scripting language application when the scripting language application is run. The method starts with the development of a compiled application (step 400), a scripting language application (step 405), and a common style sheet (step 410).

The compiled and scripting language applications can be developed as described above. Both the compiled application and the scripting language applications are developed to utilize attributes contained in the common style sheet. The common style sheet is processed by a converter (step 415). The converter generates a set of program code for the compiled application (e.g., a library). The compiled application is then compiled (step 420) along with the set of program code. The resulting object code includes the set of program code. In some embodiments, the scripting language application is compiled (step 425) along with a runtime converter component as described above. In other embodiments, compilation and/or incorporation of a runtime convert are not necessary (e.g., an HTML application accessing a cascaded style sheet).

Next, the compiled application, incorporating the common style sheet is deployed to one or more computers (step 430). The scripting language application is deployed, along with the common style sheet, to a web server or other server (step 435). When a user wants to run the compiled application, the user simply executes the application on a device to which the compiled application has been deployed (step 440). Running the scripting language application involves another application (e.g., INTERNET EXPLORER) accessing a web server to which the scripting language application has been deployed (step 445). The web server then transfers the scripting language application, along with, in some embodiments, the common style sheet, to the remote device (step 450). The application that accessed the scripting language application on the web server then runs the scripting language application (step 455).

When it is desired to modify the graphical user interfaces of the compiled and the scripting language applications, a developer modifies the common style sheet (step 460). There is no need to modify the compiled or scripting language applications themselves. Instead once the common style sheet has been modified, the common style sheet is again processed by the converter (step 415) to generate a set of program code for the compiled application (e.g., a library). The compiled application is then compiled (step 420) along with the set of program code. The resulting object code includes the compiled application and the set of program code. The compiled application is then deployed to the computer(s) (step 430) and the common style sheet is deployed to the web server or other server (step 435) for use by the scripting language application. The new graphical user interface is implemented the next time the compiled and scripting language applications are run.

Thus, the invention provides, among other things, a system and method for implementing a common graphical user interface for compiled and scripting language applications using a common style sheet. Various features and advantages of the invention are set forth in the following claims.

What is claimed is:

1. A system that presents graphical user interfaces for different applications, comprising:
a scripting language application having a first graphical user interface that includes a first plurality of objects that appear on a display device;
an application software program having a second graphical user interface, the second graphical user interface including a second plurality of objects that appear on a display device, the second plurality of objects having an appearance that is substantially identical to an appearance of the first plurality of objects;
a style sheet common to both the scripting language application and the application software program that controls the generation of the first and second pluralities of objects.

2. The system of claim 1, wherein the first graphical user interface and the second graphical user interface are substantially identical.

3. The system of claim 1, wherein the style sheet is integrated into the scripting language application and into the application software program.

4. The system of claim 1, wherein at least one of the scripting language application and the application software program is structured such that it accesses the style sheet while the respective application or program is executing.

5. The system of claim 1, wherein the scripting language application is structured such that it accesses the style sheet while the application is running and the style sheet is integrated into the application software program.

6. The system of claim 1, wherein the first plurality of objects and the second plurality of objects have the same layout on a display device.

7. The system of claim 1, further comprising a computer executing the application software program.

8. The system of claim 1, further comprising an input/output device configured to access the scripting language application.

9. The system of claim 8, further comprising a network, the input/output device configured to access the scripting language over the network.

10. The system of claim 1, further comprising a computer readable storage device, wherein at least one of the scripting language application, the application software program, and the style sheet reside on the computer readable storage device.

11. The system of claim 10, wherein the first graphical user interface and the second graphical user interface are substantially identical.

12. The system of claim 10, wherein the style sheet is integrated into the scripting language application and into the application software program.

13. The system of claim 10, wherein at least one of the scripting language application and the application software program is structured such that it accesses the style sheet while the respective application or program is executing.

14. The system of claim 10, wherein the scripting language application is structured such that it accesses the style sheet while the application is running and the style sheet is integrated into the application software program.

15. The system of claim 10, wherein the first plurality of objects and the second plurality of objects have the same layout on a display device.

16. A system that provides graphical user interfaces for different applications, comprising:
a display device;
a first application based upon a scripting computer language, the first application configured to generate a first graphical user interface including a first plurality of objects that appear on the display device;
a second application based upon a compilable computer language, the second application configured to generate a second graphical user interface that includes a second plurality of objects that appear on the display device, the second plurality of objects being substantially identical in appearance to the first plurality of objects; and
a style sheet common to both the first application and the second application that controls the generation of the first and second pluralities of objects.

17. The system of claim 16, wherein the first graphical user interface and the second graphical user interface are substantially identical.

18. The system of claim 16, wherein the style sheet is integrated into the first application and into the second application.

19. The system of claim 16, wherein at least one of the first application and the second application is structured such that it accesses the style sheet while the respective application is executing.

20. The system of claim 16, wherein the first application is structured such that it accesses the style sheet while the first application is running and the style sheet is integrated into the second application.

21. The system of claim 16, wherein the first plurality of objects and the second plurality of objects have the same layout on the display device.

22. A method of creating graphical user interfaces for a scripting language application and a compilable software program, comprising:
creating a common style sheet;
providing a scripting language application configured to access the common style sheet;
providing a compilable software program configured to access the common style sheet;
executing the scripting language application, including
accessing the common style sheet;
generating a first graphical user interface based at least in part on the style sheet and having a first plurality of objects that appear on a display device;
executing the compilable software program, including
accessing the common style sheet; and
generating a second graphical user interface based at least in part on the style sheet and having a second plurality of objects that appear on a display device,
wherein the appearance of the second plurality of objects is substantially identical to the appearance of the first plurality of objects.

23. The method of claim 22, further comprising
arranging the first plurality of objects on a display device into a layout arrangement; and
arranging the second plurality of objects on a display device into the same layout arrangement as the first plurality of objects.

24. The method of claim 22, further comprising integrating the common style sheet into the compilable software program.

25. The method of claim 24, further comprising integrating the common style sheet into the scripting language application.

26. The method of claim 22, wherein the compilable software program executes on a computer and the scripting language application runs on an input/output device.
